(19) United States
(12) Patent Application Publication
(10) Pub. No.: US 2022/0364405 A1
(43) Pub. Date: Nov. 17, 2022

(54) THERMAL-SENSING FIRE DOOR

(71) Applicant: Rob J. Evans, Glendale, AZ (US)

(72) Inventor: Rob J. Evans, Glendale, AZ (US)

(21) Appl. No.: 17/319,093

(22) Filed: May 13, 2021

(51) Int. Cl. E05F 15/72; G08B 3/10; G08B 17/10; G08B 25/00

(52) U.S. Cl. CPC E05F 15/72; G08B 3/10; G08B 17/10; G08B 25/006; E05Y 2400/20; E05Y 2400/52; E05Y 2900/132; E05Y 2900/146

(57) ABSTRACT

A fire door system is disclosed herein. The fire door system comprises a door and a door control unit coupled to the door. A plurality of sensors is configured on the door or adjacent the door. A controller is coupled to the door control unit and the plurality of sensors. The controller facilitates activation of the motorized door unit for maintaining the door in a closed position subsequent to sensing of a surrounding temperature by the plurality of sensors, wherein the surrounding temperature is greater than a threshold temperature.

### TECHNICAL FIELD

The present disclosure relates to fire door systems in general. In particular, the present disclosure relates to a fire door system that employs the usage of movable temperature sensors.

### BACKGROUND

When a fire is detected in a building having fire doors, the fire doors must be kept closed. Keeping these doors closed helps to compartmentalize the fire. In the case of overhead rolling fire doors, fire detection devices are conventionally situated well above the fire doors, near the ceiling, or even above is the ceiling panels. A typical arrangement includes one or more fusible links. A fusible link is made from pieces of metal held together by solder designed to melt when it reaches a certain temperature (e.g., 165 degrees Fahrenheit). When this happens, the fire doors will be automatically closed.

However, because heat and smoke rise there will usually be a considerable delay before the fire system is activated and the fire doors closed. In the meantime, the doorway will remain unprotected. Additionally, environmentally controlled buildings include air conditioning and heating systems that blow air downwardly or laterally. When hot air from a fire enters a room through an open fire door, it will follow this air path, causing further delay.

### SUMMARY

The present disclosure envisages a thermal sensing fire door system. The thermal sensing fire door system comprises a door and a door control unit coupled to the door. A plurality of sensors is configured on or in the door. A controller is coupled to the door control unit and the plurality of sensors. The controller facilitates activation of the door unit for maintaining the door in a closed position subsequent to sensing of a surrounding temperature by the plurality of sensors, wherein the surrounding temperature is greater than a threshold temperature.

### BRIEF DESCRIPTION OF THE DRAWINGS

FIG. 1 illustrates a schematic view of a conventional rolling fire door having fusible links disposed above the door.

FIG. 2 illustrates a block diagram of a fire door system according to a first embodiment of the present invention.

FIG. 3 illustrates an exploded view of a sensor assembly according to a first embodiment of the present invention.

FIG. 4A illustrates a perspective view of the system installed on a doorframe 400 according to a first embodiment of the present invention.

FIG. 4B illustrates a perspective view of the posterior face of the sensor assembly installed on the doorframe according a first embodiment of the present invention.

FIG. 5 illustrates a perspective view of the sensor assembly installed on a door according to the first embodiment of the present invention.

FIG. 6A illustrates a schematic view of the system installed on a rolling shutter according to the first embodiment of the present invention.

FIG. 6B illustrates an exploded view depicting positioning of sensor assembly on an edge of the rolling shutter according to the first embodiment of the present invention.

### DETAILED DESCRIPTION OF EXAMPLE EMBODIMENTS

Example embodiments of the disclosure now will be described more is fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

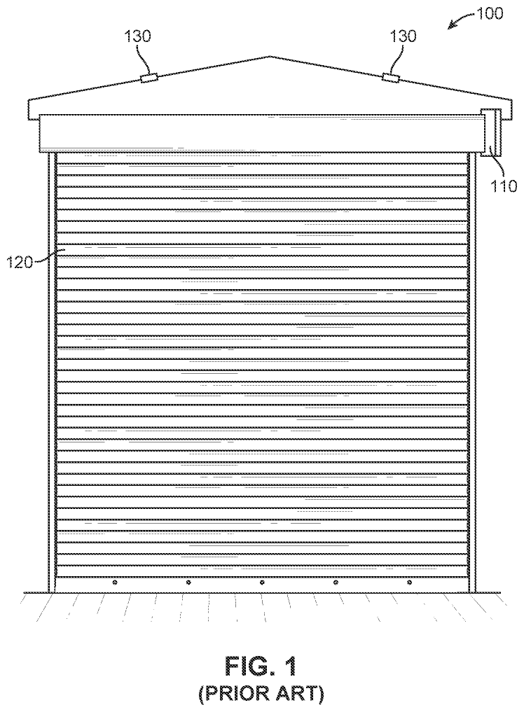

Referring to FIG. 1, a schematic view of a conventional rolling fire door having fusible links disposed above the door, is illustrated. As shown, the fire door 100 includes a control system 110 that controls operation of the gate 120. In general, the fire door should be closed when a fire is detected. Fusible links 130 are disposed above the fire door 100. The fusible links 130 may be made from pieces of metal held together by solder designed to melt when they reach a certain temperature causing an open circuit condition. In this case, the control system 110 causes the gate 120 to close. In other cases, the fire control system may additionally or alternatively include various other types of fire detection devices such as other types of thermal sensors or smoke detectors, but these also will be arranged above and away from the opening of the fire door 100 so that an indication of fire may not be realized until well after the fire doorway is breached, which is not desired.

To this end, the present subject matter envisages a thermal sensing fire door system in which the delay in sensing the fire is eliminated as much as possible, so that the preventive measures to control the fire are taken more quickly.

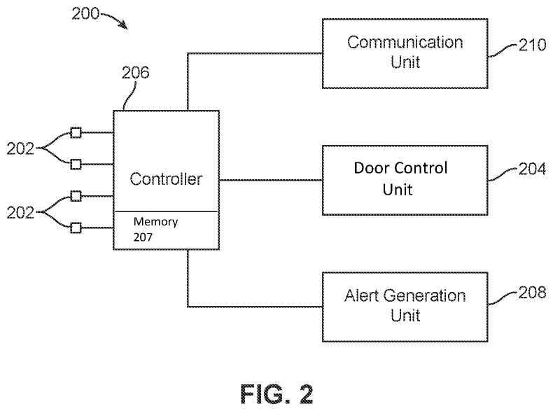

Referring to FIG. 2, a block diagram of a fire door system 200 according to a first embodiment of the present invention, is illustrated. The fire door system 200 (hereinafter interchangeably referred to as system 200) comprises a plurality of sensors 202. The plurality of sensors 202, in accordance with an embodiment of the present invention, may be installed on a door or adjacent the door, e.g., on the door frame. The door, in accordance with an embodiment of the present subject matter, may be any type of door including, but not limited to, a rolling shutter, a sliding door, a swivel door, and so on. In the present disclosure, the word door is intended to include a single door as well as a plurality of doors. In accordance with one embodiment, the plurality of sensors 202 may include temperature sensors, fusible links, smoke detectors, and the like.

The system 200 further comprises a door control unit 204. The door control unit 204 may be any door control unit known in the art. Furthermore, the door control unit 204 may have a configuration corresponding to the type of door that is being closed therewith. More specifically, the door control units used for the rolling shutter, the sliding door, and the swivel door may all have different configurations, and all such combinations and configurations are within the ambit of the present disclosure. It is to be understood that in certain cases where the door is an overhead door, the door control unit 204 closes the door by release of the door gate. In this case, the door gate falls primarily due to gravity. In such cases, the door will preferably be equipped with a speed governor or viscous wheel governor to regulate the descent speed.

The system 200 further comprises a controller 206 and memory 207 (including a set of non-transitory computer-readable instructions embedded thereon). The controller 206 can be a programmable logic controller (PLC) or the like. The computer-readable instructions can include program code to operate the controller 206. Alternatively, the controller 206 can be another type of computing device (e.g., microprocessor, general purpose computer) or even a hardwired circuit. The plurality of sensors 202 and the door control unit 204 are communicatively coupled to the controller 206. For example, in the case of a PLC, the sensors 202 can each be connected to an input module of the PLC. An input module detects the status of input signals, such as input signals from the sensors. The input signals can be evaluated by an expected voltage or resistance value. The signals can be digital signals or analog signals. The controller 206 (PLC) can include a set of output modules as well, each controlling a relevant relay, solenoid, motor, actuator, system module, etc. As shown, the output modules can control the door control unit 204, a communication unit 210, and an alert generation unit 208. The communicative coupling may include wired coupling or wireless coupling using the conventionally known connection protocols, including but not limited to, Bluetooth, Local Area Network, Wide Area Network, and the like.

The plurality of sensors 202 are configured to sense a surrounding temperature in the immediate vicinity of the door. In one embodiment, the plurality of sensors 202 may be installed integral with the door unit (on or in the door) or adjacent the gate, such as on the sill. The sensors 202 may be disposed in a spaced apart manner horizontally. Alternatively, or additionally, the sensors 202 may be disposed in a spaced apart manner vertically from near the floor up to the ceiling. An advantageous aspect of such a positioning of the sensors 202 is that the change in the surrounding temperature may be sensed as soon as the temperature increases due to a fire. The delay caused in the conventional systems due to the positioning of the sensors being near the ceiling is eliminated in the fire door system 200, in accordance with embodiments of the present disclosure.

In case of a fire, the plurality of sensors 202 are configured to sense that the surrounding temperature has exceeded a threshold temperature, and the controller 206 is configured to receive as input discrete signals from the sensors 202 in an embodiment where the sensors 202 are digital temperature sensors. The sensors 202 may sample the surrounding environment periodically or continuously. As soon as the threshold temperature has been exceeded, sensor input is received by the controller 206, and the controller 206 thereupon activates the door control unit 204 to maintain the door in the closed configuration for preventing the spread of the fire. As mentioned previously, the positioning of the sensors 202 ensures that the door control unit 204 is activated to maintain the door in closed state without any delays, as was the case with the conventional fire door systems. Although the sensors 202 have been described herein in the plural, in some embodiments usage of a single sensor 202 may suffice.

In an embodiment where the sensors 202 are fusible links, the fusible links are connected to the controller 206 in an open-circuit or a closed-circuit configuration. When one or more of the fusible link melts, it causes the circuit to either open (in the case of a normally closed circuit) or close (in the case of normal open circuit). The controller 206 may determine the status of the sensor 202 by the resistance in the circuit which will change when the fusible link has melted.

In yet another embodiment, the controller 206 may be configured to be interfaced with a smart device such as a smartphone, a computer, a tablet, and the like, for allowing manual control over the system 200. An advantageous aspect of providing manual control over the system 200 may be that the fire doors may be manually closed if at all a user visually verifies a fire has taken is place prior to the sensing of by the sensors 202. In such a scenario, the user quickly leaves the room after visually verifying the fire and uses the associated smart device to manually activate the system 200 for closing the fire doors.

At the same time, the manual control over the system 200 may also allow the user to manually over-ride the operation of the system 200 in cases where the fire was not severe but occurred at a location near the sensor 202, and was immediately extinguished by the user. In such a case, the manual over-ride feature may allow the system 200 to open the locked doors subsequent to the extinguishing of the fire.

In accordance with an embodiment of the present disclosure, the system 200 may further include an alert generation unit 208 coupled to the controller 206. The alert generation unit 208 is configured to generate loud audio alerts subsequent to the activation of the door control unit 204 by the controller 206 on sensing the fire by the plurality of sensors 202. Additionally, the alert generation unit 208 can be configured to generate visual alerts (e.g., activating a strobe light).

In accordance with an embodiment of the present disclosure, the system 200 may further include communication unit 210 coupled to the controller 206 and configured to make an SOS call to a fire department authority. The communication unit 210 is configured to make the SOS call subsequent to the activation of the door control unit 204 by the controller 206 on sensing the fire by the plurality of sensors 202. The SOS call, in accordance with one implementation, may provide the fire department authority with the GPS co-ordinates of the location where the fire has occurred. In yet another embodiment, the SOS call may also be configured to provide the fire department authority with contact details of one or more persons, who may be identified as workers or inhabitants of the location where the fire has occurred to warn them of the fire.

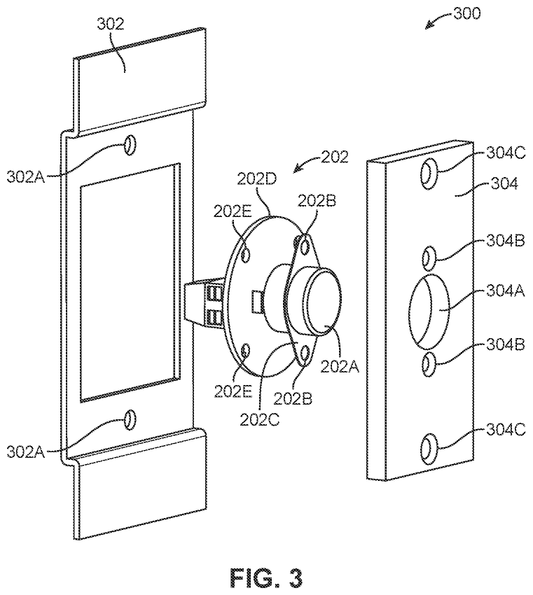

Referring to FIG. 3, an exploded view of a sensor assembly 300 according to a first embodiment of the present invention, is illustrated. The sensor assembly 300 comprises a base plate 302, a sensor 202, and a mounting plate 304. In an assembled configuration, the base plate 302 may be assembled at the location where the sensor 202 is to be installed, e.g., inside the door. The location at which the sensor 202 needs to be installed may be machined appropriately to make space for accommodating the sensor 202 and the base plate 302. More specifically, the base plate 302 is assembled at the desired location first, the sensor 202 is then positioned such that the posterior face of the sensor 202 is accommodated in the machined space, and the mounting plate 304 is then installed over the sensor 202 and connected to the base plate 302. The mounting plate 304 has an aperture 304A that allows a sensing surface 202A of the sensor 202 to be exposed for sensing the surrounding temperature.

Referring to FIG. 3, the mounting plate 304 includes apertures 304B, which in an assembled configuration of the sensor assembly 300, align with apertures 202B configured on a sensor bracket 202C of the sensor 202. The mounting plate 304 further includes apertures 304C that are configured to align with apertures 302A on the base plate 302, thereby sandwiching the sensor 202 in between the base plate 302 and the mounting plate 304 in an assembled configuration of the sensor assembly 300. The sensor 202 further includes a positioning bracket 202D, wherein the positioning bracket 202D and apertures is 202E configured on the positioning bracket 202D facilitate the secure accommodation of the sensor 202 in the machined space on the door edge or the door frame.

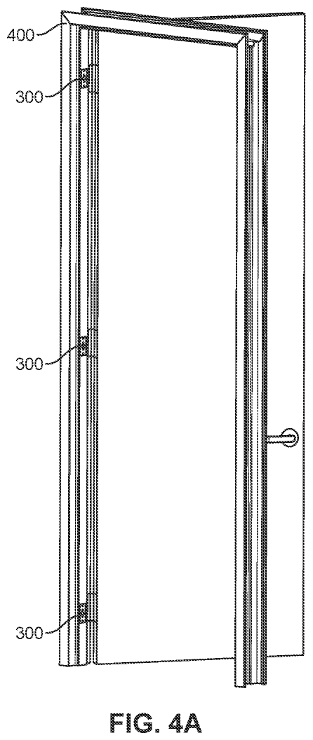

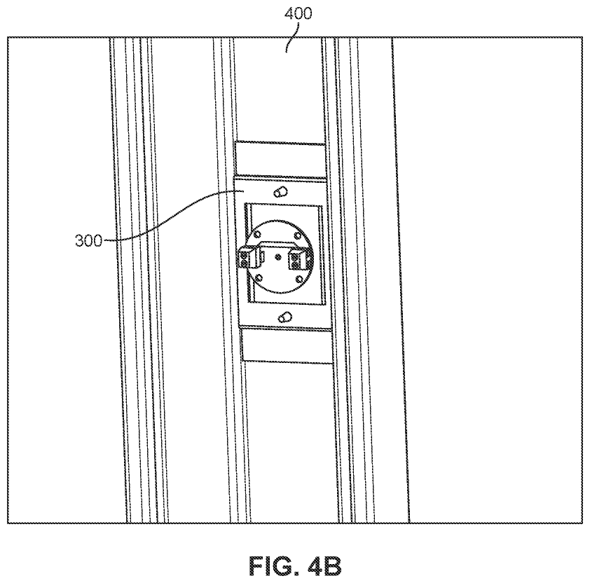

Referring to FIG. 4A, a perspective view of the system 200 installed on a doorframe 400 according to a first embodiment of the present invention, is illustrated. As seen in FIG. 4, the sensor assembly 300 is installed on the doorframe 400 in a spaced apart manner from adjacent the floor to adjacent a top edge 400A of the doorframe 400. An advantageous aspect of such an arrangement of the sensor assemblies 300 is that the rise in the surrounding temperature is detected by the sensor assemblies 300 as soon as a fire appears, as opposed to the conventional systems where the sensors were only placed near or above the top edge of the doorframe, which would sense the increased surrounding temperature with much delay (by waiting for the hot fumes to rise upward only then to be sensed by the sensors).

Referring to FIG. 4B, a perspective view of the posterior face of the sensor assembly 300 installed on the doorframe 400, is illustrated. As seen in FIG. 4A and FIG. 4B, the sensor assembly 300 is installed on the doorframe in a manner that no part of the sensor assembly 300 protrudes beyond the lateral surface of the doorframe 400.

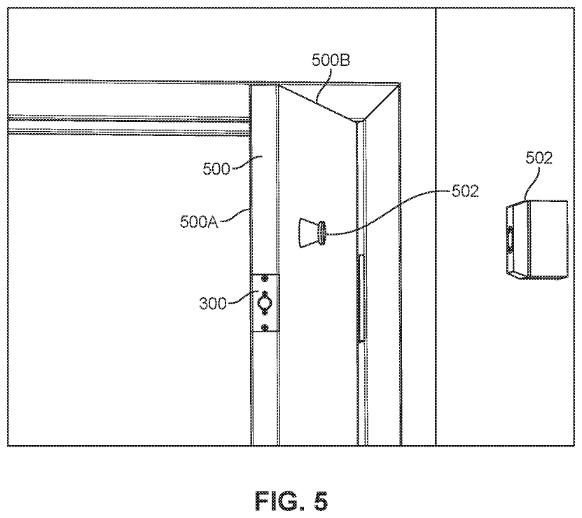

Referring to FIG. 5, a perspective view of the sensor assembly 300 installed on a door 500 according to the first embodiment, is illustrated. Similar to installation on the doorframe 400, the sensor assemblies 300 may be installed on a vertical edge 500A of the vertical door edge 500 in a spaced apart manner from adjacent the floor to adjacent a top edge 500B of the door 500. A magnetic stopper 502 is also depicted in FIG. 5 that is typically used in domestic setups for holding the door in an opened configuration.

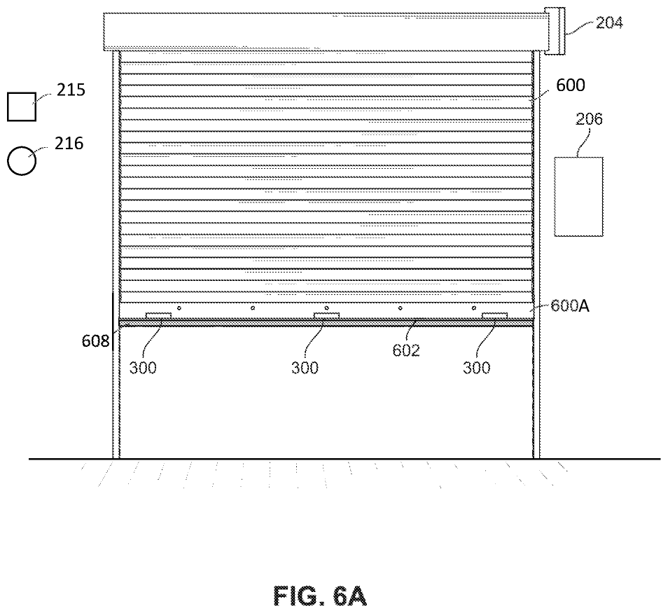

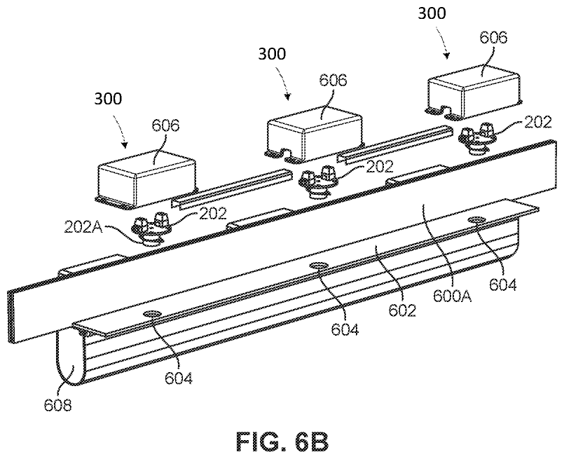

Referring to FIG. 6A, a schematic view of the system 200 installed on a rolling shutter 600 according to the first embodiment of the present invention, is illustrated. As seen in FIG. 6A, the sensor assemblies 300 are installed on a sill 602 of the rolling shutter 600. The controller 206 is shown installed adjacent the rolling shutter 600 but could be installed at a remote location. In accordance with one embodiment of the present invention, the sensors in the sensor assemblies 300 may be wirelessly coupled to the controller 206, as mentioned previously in the present disclosure. In this case, the controller 206 can be part of a central fire control system. The door release 204 is also coupled to the controller 206 for allowing a user to conveniently open and close the shutter 600.

As seen in FIG. 6A, the sensor assemblies 300 are installed on the sill 602 of the rolling shutter 600, and not on top of the rolling shutter, as was the case with the conventional fire door system depicted in FIG. 1. It is to be understood that when the rolling shutter 600 is in a more fully open position, the sensor assemblies (including the sensors) 300 will be positioned at a higher position than shown. In other words, the sensors are moveable sensors, since they travel with the door gate. Such a positioning of the sensor assemblies 300 allows the immediate detection of the increased temperatures caused due to fire. A speaker 215 and a strobe light 216 can be provided for sounding an alarm and activating a visual alert, respectively, as shown.

Referring to FIG. 6B, an exploded view depicting positioning of sensor assemblies 300 on the sill 602 of the rolling shutter 600 according to an is embodiment, is illustrated. It is to be understood that FIG. 6B depicts the sensor assemblies 300 in an enlarged manner relative to the other components, which is done for illustrative purposes and is not meant to be limiting. As seen in FIG. 6B, the sill 602 extends outwardly from the edge 600A and includes a plurality of apertures 604 configured thereon. The sensing surface 202A of the sensor 202 of the sensor assembly 300 passes through the apertures 604 after installation, thereby allowing the sensing surface 202A of the sensor 202 to sense the surrounding temperature just below the sill bracket 602. A sensor housing 606 is configured for assembly over the posterior face of the sensor 202 for providing protection to the sensor 202. A weather strip 608 is shown attached to the edge at an operative bottom end thereof

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A fire door system comprising:
a door;
a door control unit coupled to the door;
a plurality of sensors integral to the door; and
a controller, wherein the door control unit and the plurality of sensors are coupled to the controller, wherein the controller facilitates activation of the door control unit for maintaining the door in a closed position subsequent to receiving sensor input from at least one of the sensors indicative of a fire.

2. The fire door system according to claim 1, wherein the plurality of sensors are one of wireless sensors and wired sensors.

3. The fire door system according to claim 1, wherein the plurality of sensors include at least one of temperature sensors, fusible links, and smoke detectors.

4. The fire door system according to claim 1, wherein the controller is configured to operate the door in a normal operating configuration when the surrounding temperature is less than a threshold temperature.

5. The fire door system according to claim 1, wherein the door includes one of a rolling shutter, a swivel door, and a sliding door.

6. The fire door system according to claim 1, further comprising an alert generation unit coupled to the controller and configured to generate audio alerts upon the controller receiving the sensor input from at least one of the sensors indicative of a fire.

7. The fire door system according to claim 1, further comprising a communication unit coupled to the controller and configured to contact a fire department authority.
